(19) United States
(12) Patent Application Publication
(10) Pub. No.: US 2021/0112004 A1
(43) Pub. Date: Apr. 15, 2021

(54) APPARATUS AND METHOD FOR FORWARDING A PACKET IN CONTENT CENTRIC NETWORK

(71) Applicant: ELECTRONICS AND TELECOMMUNICATIONS RESEARCH INSTITUTE, Daejeon (KR)

(72) Inventor: Sung Hyuk BYUN, Daejeon (KR)

(73) Assignee: ELECTRONICS AND TELECOMMUNICATIONS RESEARCH INSTITUTE, Daejeon (KR)

(21) Appl. No.: 17/071,631

(22) Filed: Oct. 15, 2020

(30) Foreign Application Priority Data
Oct. 15, 2019 (KR) 10-2019-0127965
Oct. 15, 2020 (KR) 10-2020-0133500

(51) Int. Cl. H04L 12/741

(52) U.S. Cl. CPC H04L 45/745

(57) ABSTRACT

Disclosed herein are a packet forwarding method and a node in a content centric network. The node constituting a content centric network may perform packet forwarding by including: a plurality of interfaces configured to receive and transmit an interest packet and a data packet for a plurality of remote nodes, a pending interest table (PIT) for storing information on a local interest packet, among non-responded interest packets, of which its source network or destination network corresponds to the network in which the corresponding node is located, a tag table for storing information on a transit interest packet group associated with a source network, among non-responded interest packets, of which a source network and a destination network are not the network in which the corresponding node is located, a forwarding information base (FIB) for forwarding an interest packet to a destination node and a processor for selecting the PIT or the tag table, when packet forwarding, according to whether the packet is a local packet or a transit packet, and for performing packet forwarding based on the selected table.

### CROSS REFERENCE TO RELATED APPLICATION

The present application claims the benefit of Korean Provisional Application No. 10-2019-0127965, filed Oct. 15, 2019 and Korean Non-Provisional Application No. 10-2020-0133500, filed Oct. 15, 2020, the entire contents of which are incorporated herein for all purposes by reference herein.

### BACKGROUND OF THE INVENTION

### Field of the Invention

The present disclosure relates to an apparatus and method for forwarding a packet in a content centric network. More particularly, the present disclosure relates to a technique for newly defining a tag of a data packet or an interest packet in a content centric network and thereby efficiently processing the interest packet or the data packet.

### Description of the Related Art

The scale of data services on the Internet is growing rapidly. Meanwhile, the Internet currently operates by using IP addresses. Data requesters, that is, consumers only use IP addresses to request and receive data. In such an Internet network, when there are at least one or more users requesting the same data in a network, the data should basically be transmitted repeatedly as many times as the number of users, which causes inefficiency with respect to repeated transmission of data.

In order to solve the problem, content centric network structures, instead of IP-based network structures, are being actively studied and developed. In the present disclosure, the term “content centric network” includes a content centric network (CCN), an information centric network (ICN) and a named data network (NDN).

A network supporting the content-centric technology introduces the concept of a content publisher generating data instead of a sender/receiver and a content consumer receiving and consuming data, so that the network is capable of performing routing by using a content name instead of an IP address. A router may use a method of storing particular data, when necessary, and distributing the data to new nearby consumers requesting them.

In a content centric network, when transmitting an interest packet that carries a name of data requested by a content consumer in header, a node caching or possessing the data may respond as a data packet through data name-based forwarding. The data packet may be delivered to the data requester along a path in which the interest packet has come. Meanwhile, a node constituting a content centric network may include a content store (CS) for caching a data packet passing the node, a forwarding information base (FIB) for forwarding an interest packet based on a data name, and a pending interest table (PIT) for storing and managing information on a non-responded interest packet.

In this case, as the PIT should store information on each interest packet during the round-trip time (RTT) of the interest packet, the size of the PIT increases in proportion to the forwarding capacity of the node. However, the PIT size thus required is almost impossible to realize by the current technology, thereby disrupting the introduction of content centric networks.

### SUMMARY OF THE INVENTION

The present disclosure provides an apparatus and a method for forwarding a packet in content centric network.

According to the present disclosure, A node constituting a content centric network for packet forwarding, the node comprising: a plurality of interfaces configured to receive and transmit an interest packet and a data packet for a plurality of remote nodes, a pending interest table (PIT) for storing information on a local interest packet, among non-responded interest packets, of which its source network or destination network is the network in which the corresponding node is located, a tag table for storing information on a transit interest packet group associated with a source network, among non-responded interest packets, of which its source network and destination network are not the network in which the corresponding node is located, a forwarding information base (FIB) for forwarding an interest packet to a destination node and a processor for selecting the PIT or the tag table, when packet forwarding, according to whether the packet is a local packet or a transit packet, and for performing packet forwarding based on the selected table.

According to the present disclosure, A packet forwarding method performed by a node constituting a content centric network, the method comprising: receiving an interest packet from a content centric network, examining whether a tag is comprised in the received interest packet, and forwarding the interest packet, wherein, when the interest packet is received by an interface connected with an external network and its destination network name of the interest packet is not the same as a network name in which the node is located, or when the interest packet is received by an interface connected with an internal network and a tag is comprised in the interest packet, the received interest packet is classified as a transit interest packet.

According to the present disclosure, a packet forwarding method performed by a node constituting a content centric network, the method comprising: receiving a data packet of a content centric network, examining whether a tag is comprised in the received data packet, and forwarding the data packet, wherein, when a tag is comprised in the received data packet, an entry comprising an output tag matching the tag is looked up in a tag table and forwarding is performed based on interface information comprised in the entry.

### BRIEF DESCRIPTION OF THE DRAWINGS

FIG. 1 is a view for describing a method of forwarding a Map-n-Encap packet in a content centric network to which the present disclosure may be applied.

FIG. 2 is a view for describing a method of forwarding an interest packet based on a tag table in a content centric network according to an embodiment of the present disclosure.

FIG. 3 is a view for describing a method of forwarding a data packet based on a tag table in a content centric network according to an embodiment of the present disclosure.

FIG. 4 is a view for describing a packet forwarding method across a plurality of core networks between a content consumer and a producer that are located in different user networks in a content centric network according to an embodiment of the present disclosure.

FIG. 5 is a view for describing a packet switching method between a content consumer and a producer located in neighboring core networks in a content centric network according to an embodiment of the present disclosure.

FIG. 6 is a view for describing an example of node constituting a content centric network to which the present disclosure may be applied.

FIG. 7 is a view for describing another example of node constituting a content centric network to which the present disclosure may be applied.

FIG. 8 is a view for describing yet another example of node constituting a content centric network to which the present disclosure may be applied.

FIG. 9 is a view for describing an example of tag table in a content centric network to which the present disclosure may be applied.

FIG. 10 is a view for describing another example of tag table in a content centric network to which the present disclosure may be applied.

FIG. 11 is a view for describing an example of PIT (Pending Interest Table) supporting a tag in a content centric network to which the present disclosure may be applied.

FIG. 12 is a view for describing a packet format in a content centric network according to an embodiment of the present disclosure.

FIG. 13 is a view for describing an interest packet forwarding method implemented by a node constituting a content centric network according to an embodiment of the present disclosure.

FIG. 14 is a view for describing a data packet forwarding method implemented by a node constituting a content centric network according to an embodiment of the present disclosure.

FIG. 15 and FIG. 16 are views for describing a method of forwarding an interest packet when a network name is different from a router region in a content centric network according to an embodiment of the present disclosure.

FIG. 17 is a view for describing a method of forwarding an interest packet when a network name is identical to a router region or the interest packet may not include the network name in a content centric network according to an embodiment of the present disclosure.

FIG. 18 is a view for describing a method of forwarding a data packet in a content centric network according to an embodiment of the present disclosure.

FIG. 19 is a view for describing yet another example of node constituting a content centric network to which the present disclosure may be applied.

### DETAILED DESCRIPTION OF THE INVENTION

Hereinbelow, embodiments of the present disclosure will be described in detail so that those skilled in the art can easily carry out the present disclosure referring to the accompanying drawings. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included in the scope of the present disclosure.

In the present disclosure, components described in the various embodiments are not necessarily essential components, and some may be optional components. Accordingly, embodiments consisting of a subset of the components described in one embodiment are also included within the scope of the present disclosure. Also, embodiments that include other components in addition to the components described in the various embodiments are also included in the scope of the present disclosure.

In the present disclosure, components described in the various embodiments are not necessarily essential components, and some may be optional components. Accordingly, embodiments consisting of a subset of the components described in one embodiment are also included within the scope of the present disclosure. Also, embodiments that include other components in addition to the components described in the various embodiments are also included in the scope of the present disclosure.

In the present disclosure, the terms such as first and second are used only for the purpose of distinguishing one component from another, and do not limit the order or importance of components, etc. unless specifically stated otherwise. Accordingly, within the scope of the present disclosure, a first component in one embodiment may be referred to as a second component in another embodiment, and similarly a second component in one embodiment may be referred to as a first component in another embodiment.

When an element is simply referred to as being “connected to” or “coupled to” another element in the present disclosure, it should be understood that the former element is directly connected to or directly coupled to the latter element or the former element is connected to or coupled to the latter element, having yet another element intervening therebetween. In contrast, it should be understood that when an element is referred to as being “directly coupled” or “directly connected” to another element, there are no intervening elements present.

Meanwhile, when describing embodiments of the present disclosure, the term “content centric network” may include a content centric network (CCN), an information centric network (ICN) and a named data network (NDN).

Meanwhile, when describing embodiments of the present disclosure, a node constituting a content centric network may include a provider edge (PE)/Non-PE node.

Meanwhile, when describing embodiments of the present disclosure, the term “local packet” may be used in a sense encompassing “local interest packet” and “local interest”. Herein, the terms “local interest packet” and “local interest” may be used interchangeably.

Meanwhile, when describing embodiments of the present disclosure, the term “transit packet” may be used in sense encompassing “transit interest” and “transit interest packet”. Herein, the terms “transit interest” and “transit interest packet” may be used interchangeably.

Meanwhile, when describing embodiments of the present disclosure, a packet forwarding unit (packet forward module) may include a processor and/or PIT/tag table selection logic.

Meanwhile, when describing embodiments of the present disclosure, transit traffic or transit packet means a packet received in a node of a specific core network that is not the same as the source network and destination network of the packet. Any other packet is defined as local packet.

Meanwhile, when describing embodiments of the present disclosure, a tag means a group identifier for identifying a transit interest packet group using a same output interface of a same edge node, when a transit interest is transmitted from a source network to a core network. In addition, a tag table may mean a data table including the group identifier of the transit interest packet and information on the interest packet. Herein, “tag” and “tag table” are arbitrary names. For example, a tag may be called by other names like “identifier”, “ID” and “index”, and a tag table may be called by other names like “auxiliary table”, “identifier table”, “ID table”, “index table”, “second pending interest table (PIT)”, “auxiliary PIT” and “modified PIT”. However, the present disclosure is not limited to the names.

Hereinafter, the embodiments of the present disclosure will be described in further detail with reference to accompanying drawings.

Map-n-Encap represented by the Locator ID Separation Protocol (LISP) is one of the methods proposed so far for solving the drastic increase of border gateway protocol (BGP) routing in a core network of the current Internet. In the IP-based Internet, when a destination of a packet is a different network, the Map-n-Encap method uses tunneling by adding an IP header, which has a representative IP of the destination network as destination, when entry into a core network, and then forwarding in the core network becomes based on the destination network IP. Upon the arrival to the destination network, forwarding to the destination IP is implemented with the tunnel header being removed. Thus, as the routing entry is required only for the representative IP address in the core network, the routing entry dramatically decreases and routing scalability is secured.

In content centric networks like NDN, CCN and ICN, a packet is forwarded based on a content name. In this case, for example, when it is assumed that the number of contents in the Internet is O (10¹³) and aggregation is performed using a hierarchical name structure, the number of required domain name system (DNS) domains is estimated to be as many as O (10⁹). Accordingly, as the number of core network routing entries of IP is O (10⁶), a core network of a content centric network should process over 1,000 times as many routing entries as IP network. This has been noted as a limitation in introducing a content centric network.

To solve the problem, a technique of applying Map-n-Encap to a content centric network has been proposed. Herein, an individual network has a network name, and a router sets the name of a network, to which the router belongs, as a region. A producer, that is, a data owner registers the name of a network, to which the producer's data belong, in a name resolution server (NRS), and a consumer, that is, a data requester comes to know a name of network, in which required data are located, by making a query to NRS and then transmits an interest packet including a forwarding hint field that stores both a data name and the network name. When the network name of the interest packet is different from a region of a router, the router forwards the packet under the name of network. On the other hand, when the network name is identical to the region, the router forwards the packet under the name of data on the ground that the packet arrives at a destination network. Thus, since a routing entry is made based on not a data name but a network name in a core network of a content centric network, routing scalability may be secured.

However, when such a core network node is implemented, a pending interest table (PIT) with an actual necessary size is hard to implement, as pointed out as a limitation. More specifically, as a PIT generates an entry in each interest packet waiting for a data packet response, such an entry should maintain for round trip time (RTT) of the packet. Accordingly, the switching capacity of node increases, which results in an increase of table size. It has been estimated that the current memory technology may hardly implement PIT at a core node with over several Tbps.

Meanwhile, when a data packet, which is a response of an interest packet, returns, a PIT transmits a data packet to an incoming interface, in which the interest packet was received, so that the data packet may return in the reverse direction along the forwarding path of the interest packet. Herein, the PIT includes a data name requested by each interest packet, an incoming interface list in which each interest packet is received, lifetime, and a nonce list for detecting a loop. Herein, when a new interest packet is received requesting a data name stored in the PIT, the interest packet is integrated into a matching entry that already exists in the PIT. In addition, based on the PIT, one data packet may be multicast to a plurality of data requesters (consumers) through an interest packet integration function that updates the incoming interface list and the nonce list, which may improve the efficiency of repeated transmission of data. Also, a function of detecting a loop of interest packet through a nonce may be implemented through a PIT.

However, the effect of multicast through interest packet integration is significant mainly in an edge adjacent to a data consumer but not significant in a core network. Also, as an interest loop may be solved by adding a limit value (HopLimit) like time to live (TTL) of IP other than nonce to an interest packet, instead of PITs with limited scalability, an alternative PIT technique is being studied to provide only a function of enabling a data packet to return along an interest packet path in a core network.

Accordingly, the present disclosure proposes a tag table as an available auxiliary table, instead of a PIT, for a transit packet occupying the majority of traffic of a core network in a node located in the core network of a content centric network, that is, for a packet that is generated in a different network from a network to which the node belongs and of which the destination network does not include the node. According to the present disclosure, an existing PIT may be used for a packet that is generated in a network to which a node of a content centric network belongs or a packet of which the destination network includes the node of the content centric network. Thus, a core network node with over several Tbps may be implemented by means of a PIT with an appropriate size and an auxiliary table (tag table).

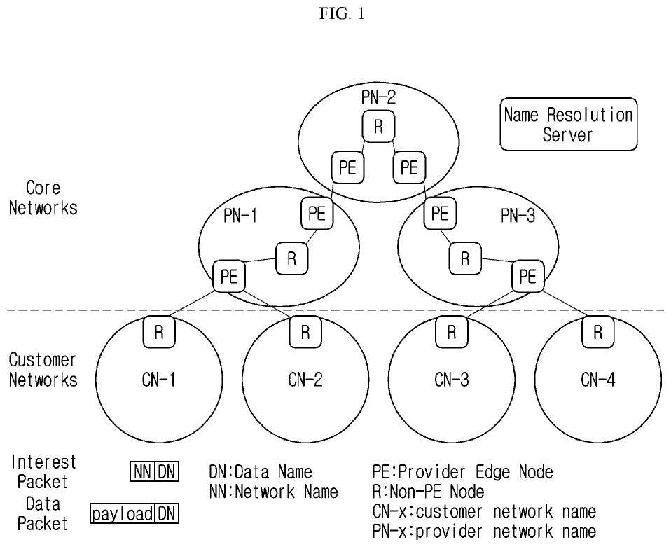

FIG. 1 is a view for describing a method of forwarding a Map-n-Encap packet in a content centric network to which the present disclosure may be applied.

In one embodiment, every network may have a network name, and nodes constituting each network are capable of knowing the name of a network, in which desired data are located, through NRS. As mentioned above, according to the present disclosure, a node may include a provider edge (PE) node and non-PE node. The PE node is located on the edge of an Internet service provider (ISP) network and may be a node connected to another provider network or a customer network. A node of a customer network and an internal node of a provider network may be classified as non-PE nodes.

In one embodiment, according to the present disclosure, a provider network may mean a network supporting the routing of transit traffic, of which the source and destination are not the network, and a customer network may mean a network that does not support transit traffic.

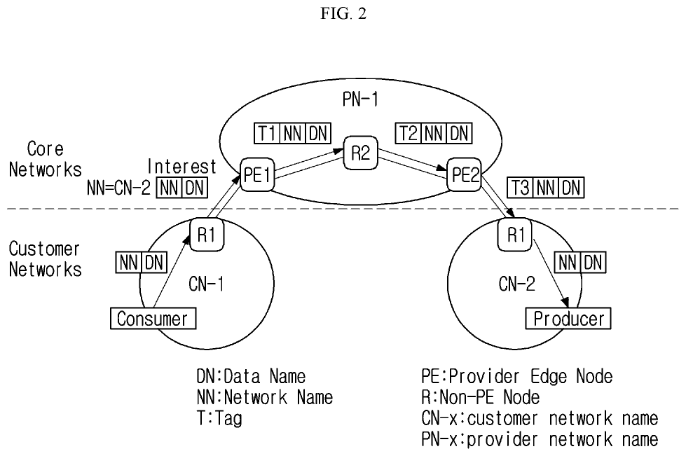

FIG. 2 is a view for describing a method of forwarding an interest packet based on a tag table in a content centric network according to an embodiment of the present disclosure.

In one embodiment, there may exist content centric networks like the customer networks CN-1 and CN-2 and the provider network PN-1. CN-1 and CN-2 may be connected to the provider network PN-1. It is assumed that a data requester (consumer) of CN-1 transmits an interest packet requesting the data of a data owner located in CN-2. When transmitting the interest packet, the header conversion of the interest packet may be necessary. The data requester may transmit the interest packet by including the network name NN=CN-2 of the data owner in the interest packet. A tag may or may not be included in the interest packet. When the tag is not included, the tag T1 may be included in the node PE1 that is an ingress edge node of PN-1. Herein, as the tag T1 is newly assigned, T1 may be expressed as an output tag (out_tag). As a current tag, that is, the original tag (in_tag) of interest packet does not exist, it may be null. PE1 may add (or update) {in_tag, in_if, out_tag} to a tag table after receiving the interest packet. Herein, in_if may mean an incoming interface, that is, an interface receiving the interest packet in PE1.

In one embodiment, after storing {null, in_if, out_tag=T1} in a tag table, an interest packet may be forwarded to R2, which is a non-PE node located in PN-1, in order to forward the interest packet to the network (CN-2) to which a data owner belongs. Herein, the current tag (in_tag) of the interest packet is T1, and R2 may swap the current tag (in_tag) of the interest packet with T2. As a PE node that is an egress node, PE2 to which the interest packet is forwarded may swap again the current tag (in_tag) to T3. Next, PE2 may forward the interest packet to R3 that is a non-PE node and an edge node of CN-2. As the name of a network to which the data requester of the input interest packet belongs is CN-2, R3 may recognize that the destination network is a network to which it belongs. Accordingly, after removing the tag and storing tag=T3 in PIT, R3 may forward the interest packet to the data owner (producer).

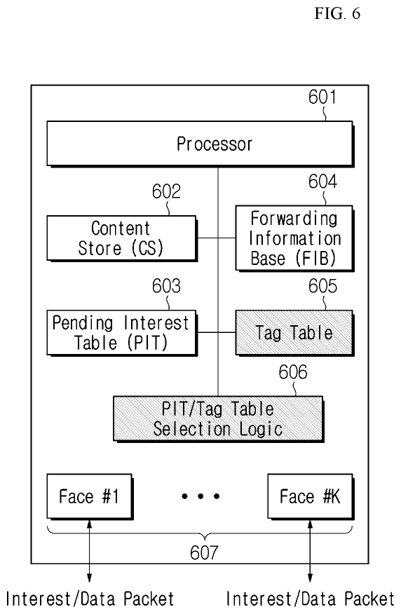

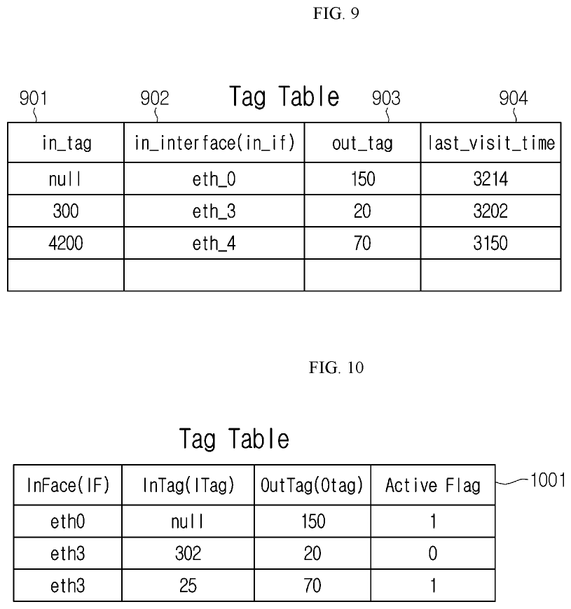

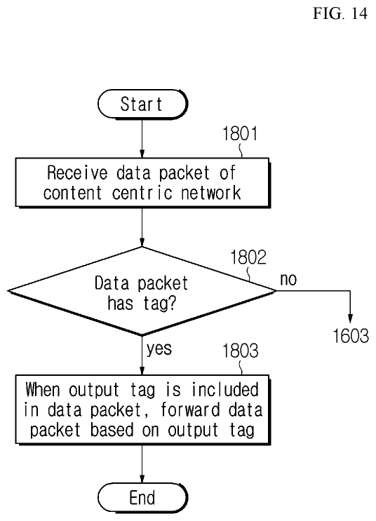

Meanwhile, R1, R2, R3, PE1 and PE2, which are nodes constituting the above-mentioned content centric network, will be described in further detail with reference to FIGS. 6 to 8 and FIG. 19. The method of processing an interest packet and a data packet in a content centric network will be described in further detail with reference to FIGS. 13 to 19. In addition, the above-mentioned PIT, tag table and packet may be the same as described in FIGS. 9 to 12.

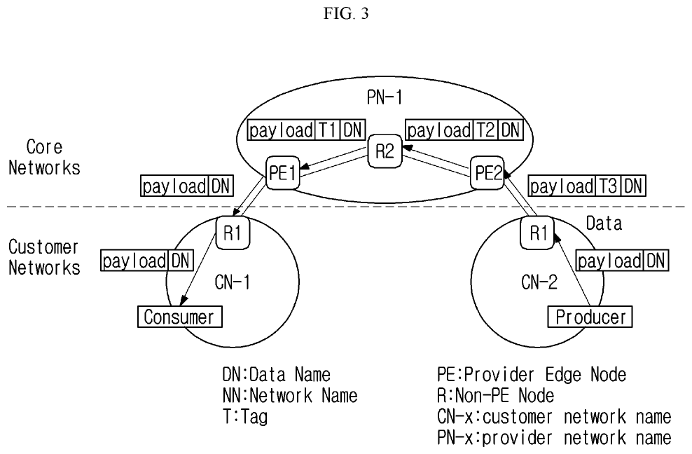

FIG. 3 is a view for describing a method of forwarding a data packet based on a tag table in a content centric network according to an embodiment of the present disclosure.

In one embodiment, there may exist content centric networks like the customer networks CN-1 and CN-2 and the provider network PN-1. CN-1 and CN-2 may be connected to the provider network PN-1.

In one embodiment, like FIG. 2, FIG. 3 may illustrate a process in which, after receiving an interest packet transmitted from a data requester, a data owner transmits a data packet as a response to the data requester. For the purpose of clarity, it is assumed below that the process of FIG. 2 is performed beforehand. In other words, the process of FIG. 3 may be a process in which the data owner (producer) of CN-2 transmits a data packet to the data requester (consumer) of CN-1.

In one embodiment, only a data name may be included in a header of a data packet that a data owner located in CN-2 transmits to a data requester located in CN-1. That is, tag may not be included in the data packet. An output tag (tag=T3) for the data name may be stored in a PIT of R3 that is an edge node located in CN-2. Herein, the PIT may be looked up based on the data name of the header, and the output tag (tag=T3) matching the data name in the PIT may be added to the data packet. Next, the data packet may be forwarded to an interface associated with the matching tag (interface of the interest packet) and thus be delivered to PE2 of PN-1.

In addition, the tag T3 may be searched in the node PE2 for an output tag field ({out_tag} field) of tag table. In this regard, a tag of a data packet itself does not mean an output tag but may be utilized as information for searching an output tag field(column) of a tag table. When a matching entry is retrieved from PIT by searching for the tag, the tag (T3) of the data packet may be swapped with T2, which is a matching interest group tag (in_tag), by obtaining {in_tag, in_if} of the entry and be forwarded to a matching interface (in_if). Likewise, in the node R2 to which the interest packet is forwarded by PE2, a current tag of data tag, that is, T2 may be searched for the output tag field ({out_tag} field, {out_tag} column) of tag table. When a matching entry is retrieved by searching for the tag, the tag (T2) of the data packet may be swapped with T1, which is a matching interest group tag (in_tag), by obtaining {in_tag, in_if} of the entry and be forwarded to a matching interface (in_if). Herein, based on the tag table of the node PE1 to which the data packet is forwarded, when searching for an entry matching the tag (T1), it may be known that the interest packet did not include the tag (tag=null). In other words, when out_tag field(column) of the tag table is searched by T1, {null, in_if} may be returned. Herein, because of in_tag=null, the data packet may be forwarded to the interface (in_if), in which the interest packet is input, after removing the tag of the data packet.

Meanwhile, R1, R2, R3, PE1 and PE2, which are nodes constituting the above-mentioned content centric network, will be described in further detail with reference to FIGS. 6 to 8 and FIG. 19. The method of processing an interest packet and a data packet in a content centric network will be described in further detail with reference to FIGS. 13 to 19. In addition, the above-mentioned PIT, tag table and packet may be the same as described in FIGS. 9 to 12.

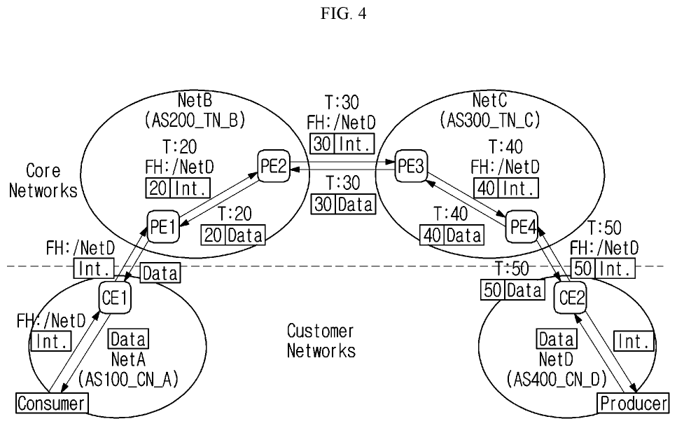

FIG. 4 is a view for describing an example of using a tag table in a packet forwarding method based on a plurality of core networks in a content centric network according to an embodiment of the present disclosure. Particularly, FIG. 4 shows an example of using a tag table according to a delivery path of interest packet and data packet in accordance with the above-described FIG. 2 and FIG. 3.

Referring to FIG. 4, for example, there may exist content centric networks including the provider networks NetB and NetC and the customer networks NetA and NetD. Herein, FIG. 4 illustrates a case in which a data owner and a data requester exist in the customer networks NetD and NetA.

More specifically, FIG. 4 is a view for describing a packet exchange process in which the data requester belonging to the customer network NetA requests data of the data owner belonging to the customer network NetD and receives the data. In this case, a tag of interest packet may be changed to 20, 30, 40 and 50 via NetB and NetC. On the contrary, a tag of data packet may be changed to 50, 40, 30 and 20 via NetB and NetC. This process may be the same as the process referring to FIG. 2 and FIG. 3 and be described in further detail with reference to another drawing below.

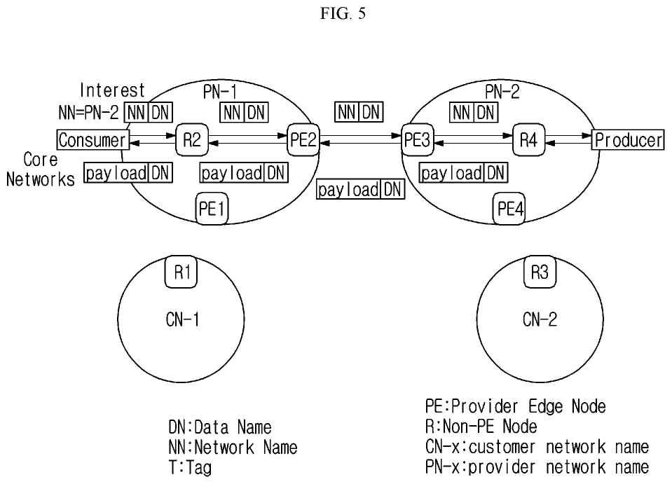

FIG. 5 is a view for describing a method of switching packets between neighboring core networks in a content centric network according to an embodiment of the present disclosure.

Referring to FIG. 5, for example, there may exist content centric networks including the provider networks PN-1 and PN-2 and the customer networks CN-1 and CN-2. Herein, FIG. 5 illustrates a case in which a data owner (producer) and a data requester (consumer) exist in the neighboring provider networks PN-1 and PN-2 respectively.

More specifically, FIG. 5 is a view for describing a packet exchange process in which the data requester belonging to the provider network PN-1 requests data of the data owner (producer) belonging to the neighboring provider network PN-2 and receives the data. In this case, as PN-1 and PN-2 are the source network and destination network of an interest packet respectively, the interest packet may be classified as a local interest packet both in PN-1 and in PN-2. Accordingly, no tag may be included in the packet.

FIG. 6 is a view for describing an example of node constituting a content centric network to which the present disclosure may be applied.

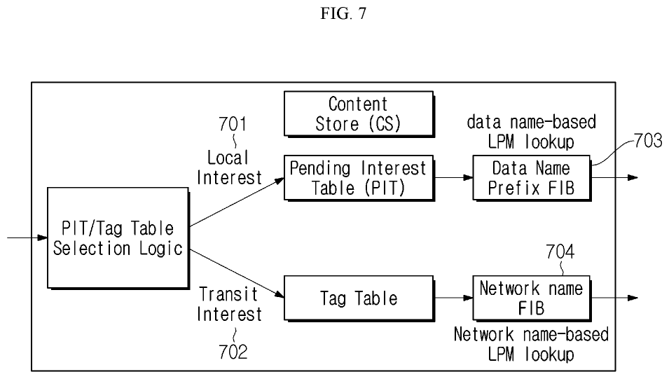

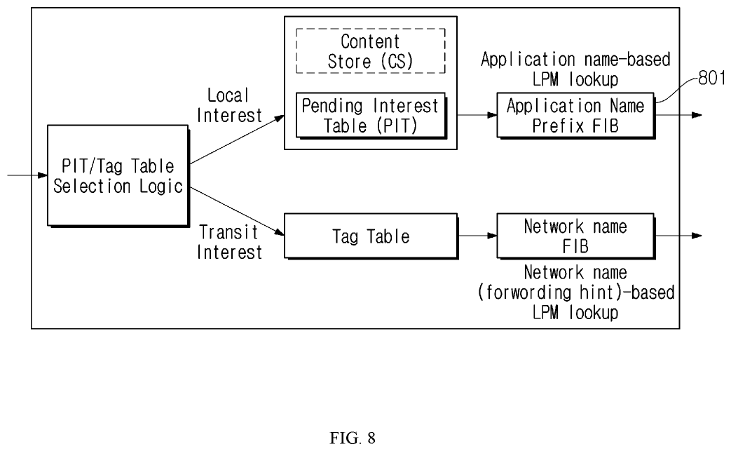

In one embodiment, the node of FIG. 6 may be a provider edge (PE) node or a non-PE node and include a processor 601, a content store (CS) 602, a pending interest table (PIT) 603, a forwarding information base (FIB) 604, a tag table 605, a PIT/Tag Table Selection Logic 606, and at least one interface 607. However, the configuration of FIG. 6 is merely illustrative to describe the present disclosure. Accordingly, it is clear that some or all parts of the configuration of FIG. 6 may be integrated and be implemented in a single hardware or software component. For example, the PIT/Tag Table Selection Logic 606 may be implemented as one component of the processor 601. This may be applied to FIG. 7 and FIG. 8 that will be described below.

In one embodiment, the processor 601 may perform overall control for other components 602, 603, 604, 605, 606 and 607 of the node, create an interest packet and a data packet and transmit and receive the interest packet and the data packet through an interface. In one embodiment, the processor may interlock with the PIT/Tag Table Selection Logic and perform a series of processes for packet forwarding. In one embodiment, a processor may be involved in initializing each table, and a packet forwarding process may be performed in each table implementation logic. The packet forwarding process may include the above-described FIGS. 2 to 5 and FIGS. 13 to 18 that will be described below. When a tag is included in a received packet, the processor may look up the tag of the received packet and an entry matching an interface of the received packet in the tag table based on the PIT/Tag Table Selection Logic. In addition, when the lookup is successful, the processor may swap the tag (in_tag) of the packet for an output tag (out_tag) based on the tag table or swap the output tag (out_tag) for the tag (in_tag). On the other hand, when the lookup fails in the tag table, the processor may swap the tag of the received packet for an output tag by allocating the output tag. In addition, when no tag is included in a received packet, the processor may provide a tag to the received packet based on an interface in where the packet is received. The tag given to the packet and the interface in which the packet is received may be added to the tag table. When the received packet is received from an external network, the processor may forward the packet through the lookup of the network name FIB (Forwarding Information Base). When the received packet is received from an internal network, the processor may forward the packet through the lookup of the data name prefix FIB. When the network name of the received packet is the same as a router region, the processor may forward the packet through the lookup of the data name prefix FIB. When a tag is included in the received packet, the processor may update the PIT (Pending Interest Table) on the tag and the interface in which the packet is received.

In one embodiment, when a data packet is received through the interface and the data packet includes an output tag, the processor may look up an entry matching the output tag in the tag table. The processor may swap the output tag for the interest packet tag of the matching entry and forward the received packet to the interface of the matching entry. When the received data packet does not include any output tag, the processor may forward the packet through a tag and an interface of an interest packet, which are obtained based on a data name prefix in a pending interest table (PIT).

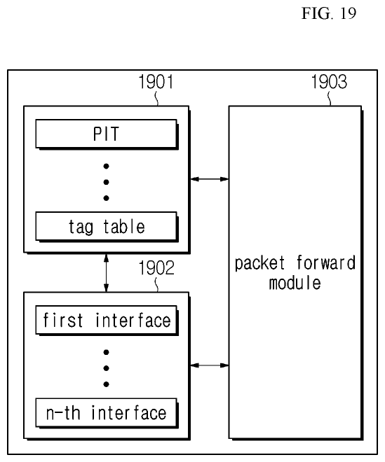

Meanwhile, for example, a processor may be expressed as a packet forward module. This will be described in further detail in FIG. 19.

In one embodiment, the content store 602 may perform caching of a data packet that has passed through a corresponding node.

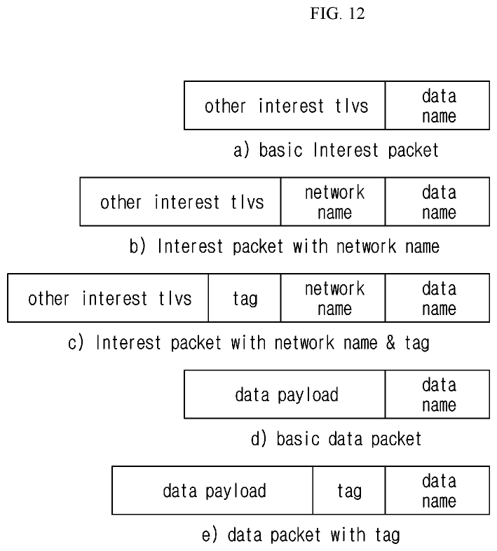

In one embodiment, the PIT 603 may be a table that stores information on an interest packet not receiving a response of data packet. This will be described in further detail in FIG. 11.

In one embodiment, the FIB (Forwarding Information Base) 604 may be based on a data name prefix and a network name. The node may forward an interest packet by looking up the FIB.

In one embodiment, the tag table 605 may include table type information associated with an interest packet and a tag assigned to a packet in each interface that may be used for transit traffic towards a different network. Herein, the tag may include a general tag (input tag, in_tag) and an output tag (out_tag). For example, the tag table may include at least any one of a tag of the received packet, an output tag for forwarding the received packet, information on the last reception time of the received packet, and a flag for the aging management of the received packet. This may be the same as mentioned above and will be described in further detail in FIGS. 7 to 19 below.

In one embodiment, the PIT/Tag Table Selection Logic 606 may perform overall control for a tag table. In addition, the PIT/Tag Table Selection Logic 606 may appropriately select a PIT or a tag table depending on whether or not an interface in which an interest packet is input is connected to an external network and whether or not a network name of interest corresponds to a region of node, that is, a router region. In one embodiment, for a data packet, when a tag is included, a tag table may be selected. When no tag is included, a PIT may be selected. More specifically, according to the PIT/Tag Table Selection Logic, when an interest packet is received from an external network and a network name is different from a region of node, that is, a router region, a tag table may be selected. When the interest packet is received from an internal network and the interest packet includes a tag, a tag table may be selected. Otherwise, a PIT may be selected. Herein, the node may recognize whether a network connected to each interface is an internal network or an external network either based on a preset value or by means of a control protocol between appropriate routers. Also, in one embodiment, the processor may be connected with or include the PIT/Tag Table Selection Logic. Based on a tag table, the PIT/Tag Table Selection Logic may directly swap a tag of packet (in_tag) for an output tag (out_tag) or swap the output tag (out_tag) for the tag (in_tag).

In one embodiment, the at least one interface 607 may transmit and receive an interest packet and a data packet to and from a plurality of remote nodes.

Meanwhile, since the node of FIG. 6 and the nodes below correspond to one embodiment, some components may be excluded or other components may be further included. In addition, a single component may be implemented in a plurality of hardware or software components, and a plurality of components may be implemented in a single hardware or software component. In one embodiment, the processor 601 and/or the PIT/Tag Table Selection Logic 606 may be expressed as a single processor or a single packet forward module. This will be described in further detail in FIG. 19.

In one embodiment, the description of FIG. 6 may be applied to the nodes of FIG. 7 and FIG. 8 respectively, unless it is inconsistent with the description of FIG. 7 and FIG. 8.

FIG. 7 is a view for describing another example of node constituting a content centric network to which the present disclosure may be applied. More specifically, FIG. 7 is a view for describing in detail a configuration of PIT, a tag table and PIT/Tag Table Selection Logic and a FIB configuration, which may be included in a node constituting a content centric network.

In one embodiment, although not illustrated, the node of FIG. 7 may include a processor, a content store and at least one interface apart from the PIT, the tag table, the PIT/Tag Table Selection Logic and the FIB.

In one embodiment, the FIB of the node may include a data name prefix FIB and a network name FIB. When processing a local interest packet 701 that is an interest packet existing in a network of a data requester or a data owner, a data name prefix FIB 703 may be looked up after CS processing and lookup in PIT.

On the other hand, in the case of a transit interest packet 702 that is an interest packet existing in other networks, a network name FIB 704 may be looked up through a tag table. Herein, the lookup of the network name FIB may be performed based on a forwarding hint field that stores a network name along with a data name included in an interest packet.

In this case, the lookup of the data name prefix FIB or the network name FIB may be based on a longest prefix match (LPM)lookup method.

In one embodiment, also in the case of a transit interest packet, since a network name of the transit interest packet may generally have a much shorter and limited length than a data name prefix, when a network name FIB is separated from a data name prefix FIB, the network name FIB may be quickly looked up by hardware like a ternary content-addressable memory (TCAM), thereby providing excellent temporal performance in the FIB lookup. As the majority of traffic in internet core networks is transit traffic, a high-capacity core router of a content centric network may be facilitated by separating a network name FIB looked up by transit traffic.

FIG. 8 is a view for describing yet another example of node constituting a content centric network to which the present disclosure may be applied. More specifically, FIG. 8 is a view for describing in detail a configuration of PIT, a tag table and PIT/Tag Table Selection Logic and a FIB configuration, which may be included in a node constituting a content centric network.

In one embodiment, the interest packet of FIG. 8 may include an application name instead of a data name. In addition, although not illustrated, the node of FIG. 8 may include a processor, a content store and at least one interface apart from the PIT, the tag table, the PIT/Tag Table Selection Logic and the FIB. Herein, a content store (CS) caching a data packet passing the node may not be included. When the content store is included in the node, it may be implemented as hardware or software connected with PIT.

In one embodiment, the interest packet may include an application name instead of a data name and include a network name. The FIB of the node may include an application name prefix FIB 801 and a network name FIB. Herein, the network name FIB may be the same as described in FIG. 7 above. When processing the local interest packet that is an interest packet existing in a network of a data requester(consumer) or a data owner(producer), the application name prefix FIB 801 may be looked up through CS and PIT lookup.

On the other hand, in the case of a transit interest packet that is an interest packet existing in other networks, a network name FIB may be looked up through a tag table, as mentioned above. Herein, the lookup of the network name FIB may be performed based on a forwarding hint field that stores a network name along with a data name included in an interest packet.

In this case, the lookup of the data name prefix FIB or the network name FIB may be based on a longest prefix match (LPM) lookup method.

FIG. 9 is a view for describing an example of tag table in a content centric network to which the present disclosure may be applied.

In one embodiment, a tag table may include a tag (input tag, in_tag) 901, an interface (in_interface, in_if) 902, an output tag (out_tag) 903, and a last reception time (last_visit_time) 904. Each field order of the tag table is given at random and is not limited to FIG. 9.

In one embodiment, the tag (in_tag) 901 may mean a current tag (or input tag) of an interest packet. The tag is not invariable and may change while packet transit is being performed. When forwarding an interest packet, the tag of the packet may be the in_tag value. For example, the tag may change to the output tag (out_tag) value whenever passing through a node processing transit traffic. When forwarding a data packet, the tag of the packet may be the out_tag. For example, the tag may change to a tag value corresponding to in_tag whenever passing through a node processing transit traffic. This is the same as mentioned above and may be described in further detail with reference to other drawings below.

In one embodiment, the interface (in_interface, in_if) 902 may be an interface in which an interest packet is input. As mentioned in FIG. 6, there may be one or more interfaces, which may be used to transmit and receive an interest packet and a data packet to and from a remote node.

In one embodiment, the output tag (out_tag) 903 is a tag value that is obtained as a tag varies while an interest packet is forwarded. The output tag (out_tag) 903 may be determined from an entry matching a tag (in_tag) of a tag table. In other words, the output tag (out_tag) 903 may be a matching value that is obtained by searching a tag table by {in_tag, in_if} based on an interest packet including in_tag. An output tag, which is a matching value, may become a tag value of an interest packet when the packet is forwarded. A data packet, which is a response of the interest packet, may include the output tag (out_tag). The output tag (out_tag) may be a unique value assigned to each interface, that is, each entry of tag table in a node. Meanwhile, the output tag may be a tag included in the data packet. As an entry matching the output tag is successfully searched in a tag table, the tag of the data packet may change to a value corresponding to in_tag. This is the same as mentioned above and may be described in further detail with reference to other drawings below.

In one embodiment, the last reception time (last_visit_time) 904 may represent a last reception time of interest packet that matches a corresponding entry or is input into a corresponding interface. In one embodiment, a tag table aging time may be set for each node. When a value obtained by subtracting a last reception time (last_visit_time) from a current time at an appropriate interval is greater than the aging time, a corresponding entry may be removed. The last reception time (Last_visit_time) may be updated not for each matching interest packet but for interest packets that are sampled at a certain rate, for example, 1/1000 or at a certain interval, for example, every second.

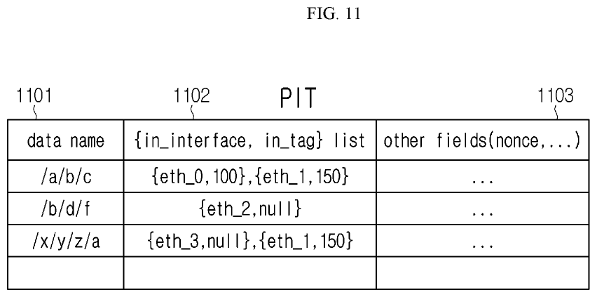

FIG. 10 is a view for describing another example of tag table in a content centric network to which the present disclosure may be applied.

In one embodiment, InFace (IF) of FIG. 10 may be the same as 902 of FIG. 9. InTag (ITag) may be the same as 901 of FIG. 9. OutTag (Otag) may be the same as 903 of FIG. 9.

In one embodiment, a tag table may simply manage interest packet information by using an active flag 1001 for aging management, instead of a last reception time (last_visit_time). In one embodiment, the aging information may be managed for each entry of the tag table. a predetermined aging time period may be set to the tag table, and the active flag may be reset to ‘0’ at the onset of each period. Next, when an interest packet accesses an entry of a specific tag, that is, when the interest packet accesses an entry matching an interface of the interest packet, the active flag may be set to ‘1’.

When an aging time period terminates, the tag table aging management may be simplified by removing an entry that has an active flag of 0 until then. As this method may significantly reduce the number of revisions of an entry, when a tag table is looked up for an interest packet that is matched after the entry is created in the tag table, the performance of the tag table lookup may be improved.

In the present disclosure including FIG. 9 and FIG. 10, a tag table may create a new entry, when there is no entry searched and selected in the tag table, that is, when no {in_tag, in_if} pair matching a tag (in_tag) of an interest packet exists in the tag table. Herein, when creating the entry, an output tag (out_tag) value, which is to be a new tag of the interest packet, may be assigned a unique value in a node. Herein, when there is no tag in a received interest packet, it may be stored as in_tag=null. When the tag table is looked up for an interest packet, the {in_tag, in_if} field may be searched. When the tag table is looked up for a data packet with a tag, the {out_tag} field may be searched. The tag table may be implemented by a ternary content-addressable memory (TCAM).

Meanwhile, a single table may support a lookup for an interest packet and a lookup for a data packet at the same time, and it is also possible to distinguish a tag table for interest packet search and a tag table for data search.

FIG. 11 is a view for describing an example of PIT (Pending Interest Table) supporting a tag in a content centric network to which the present disclosure may be applied. In one embodiment, the PIT of FIG. 11 may be compatible with the above-described tag table. In other words, the tag table and the PIT may be selectively used according to packets to be forwarded. In yet another embodiment, when a node is not located in a core network supporting transit traffic, only PIT without a tag table may be implemented and used for packet forwarding.

In one embodiment, the modified PIT of FIG. 11 may include a data name 1101, an interface-tag pair list 1102 and other fields 1103.

In one embodiment, a general PIT stores an incoming interface list for a data name, while the modified PIT supporting a tag may store the {interface (in_interface), tag (in_tag)} (or {tag, interface}) list 1102. When an interest packet without tag is received, null may be recorded in the in_tag field of the modified PIT. In one embodiment, as the data name/x/y/z/a 1101 of FIG. 11 is requested simultaneously from an internal network and an external network of a data requester, an interest packet without tag may be received from the internal network in the eth_3 interface of a node, and an interest packet with tag=150 may be received from the external network in the eth_1 interface of the node.

Meanwhile, in the case of a data packet including no tag, the modified PIT may be used to search for a matching entry based on a data name. When the matching entry is successfully searched, an incoming interface and a tag value of an interest packet may be obtained, and a data packet may be forwarded through the incoming interface that is obtained including the obtained tag value.

In one embodiment, a nonce value or other information may be recorded in the other fields 1103.

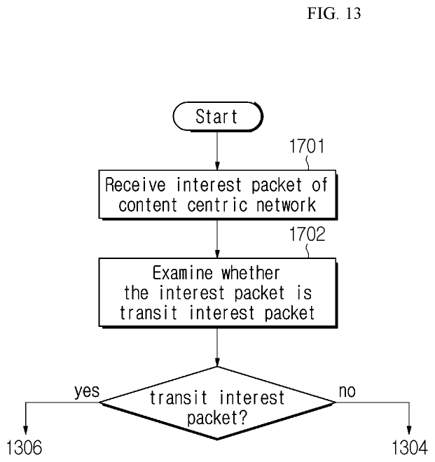

FIG. 12 is a view for describing a packet format in a content centric network according to an embodiment of the present disclosure. More specifically, FIG. 12 is a view for describing various examples of packet formats in a content centric network that may be applied to the present disclosure.

In one embodiment, an interest packet and a data packet may be included in a content centric network packet. Apart from an interest packet with basic structure and data packet formats as shown in a), d) and e) in FIG. 12, an additional packet format may exist in a content centric network.

a) in FIG. 12 is an example of basic interest packet not including a network name. In this case, a node constituting a content centric network may perform forwarding based on a data name by processing a network name of an interest packet as the same case as a region of the content centric network node, that is, a region (router region) of a node receiving a current interest packet.

b) is an example of a general interest packet to which a network name is added, and c) is an example of a transit interest packet, that is, an interest packet with a network name and a tag being added. d) is an example of a general data packet format including only a data payload and a data name, and e) is an example of a data packet format including a tag.

Meanwhile, the above-mentioned interest packet, PIT and tag table may be the same as described above with reference to FIGS. 9 to 12.

Forwarding processes for an interest packet and a data packet in a content centric network node proposed by the present disclosure are described by flowcharts in FIGS. 13 to 18.

FIG. 13 is a view for describing an interest packet forwarding method implemented by a node constituting a content centric network according to an embodiment of the present disclosure.

In one embodiment, the interest packet forwarding method of FIG. 13 may be based on the packet forwarding process of FIGS. 2 to 5 and FIGS. 15 to 18.

In one embodiment, a node performing the interest packet forwarding method of FIG. 13 may exist in a same network as a node in which a data requester is located, in a same network as a node in which a data owner is located or in any other network in which transit traffic is processed. In addition, the node may be a PE node or a non-PE node in FIGS. 6 to 8 and FIG. 19 but is not limited thereto.

In one embodiment, a node may receive 1701 an interest packet of the content centric network first. The received interest packet may be one of the interest packets in FIG. 12. The interest packet may be received through an interface of the node.

Herein, it may be examined whether the received interest packet is a local interest packet or a transit interest packet 1702. When a network name of an interest packet received from an interface connected with an external network is not the same as a router region of a node or when a tag is included in an interest packet received from an interface connected with an internal network, such interest packet may be classified as a transit interest packet. All the other packets (interest packets) may be classified as local interest packets. In other words, when a network name of an interest received from an external network is the same as a router region of a node or when an interest received from an internal network does not include a tag, this may be classified as a local interest packet.

When an interest packet is classified as a transit interest packet, tag table processing is performed 1306 process and then packet processing is performed through FIB lookup based on a network name. When the interest packet is not a transit interest packet, that is, when the interest packet is a local interest packet, PIT processing is performed 1304 process and then packet processing is performed through FIB lookup based on a data name.

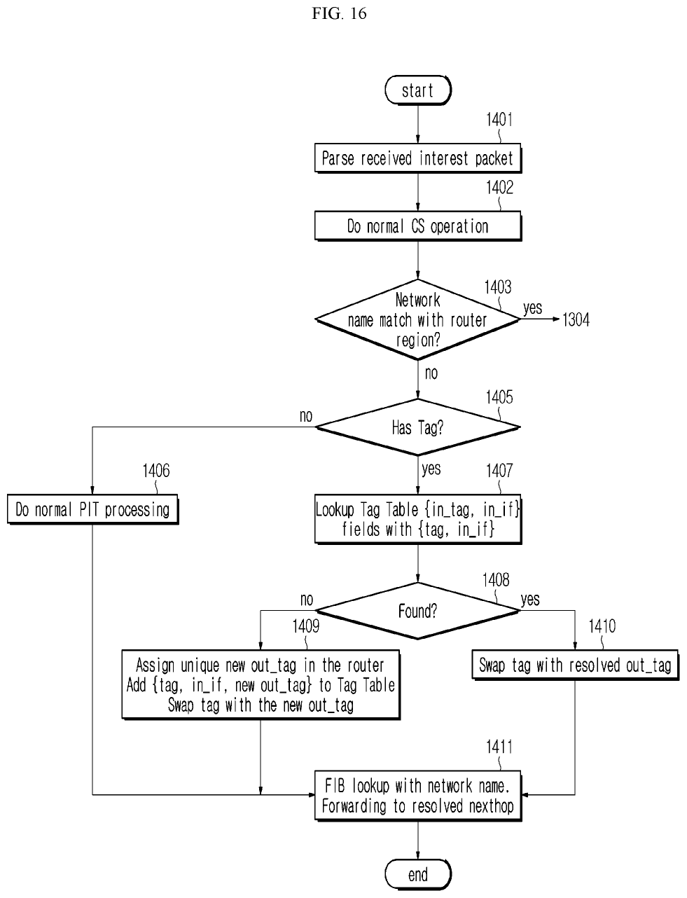

Meanwhile, the above-described S1304 and S1306 will be described in further detail with reference to FIGS. 15 to 17.

This will be described in further detail with reference to FIGS. 15 to 18 below.

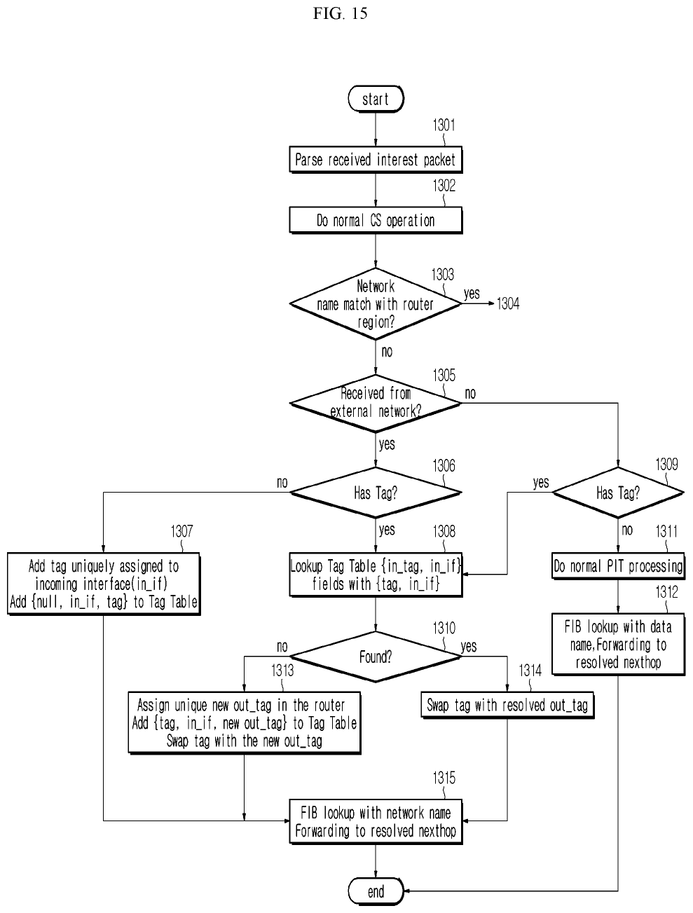

FIG. 14 is a view for describing a data packet forwarding method implemented by a node constituting a content centric network according to an embodiment of the present disclosure.

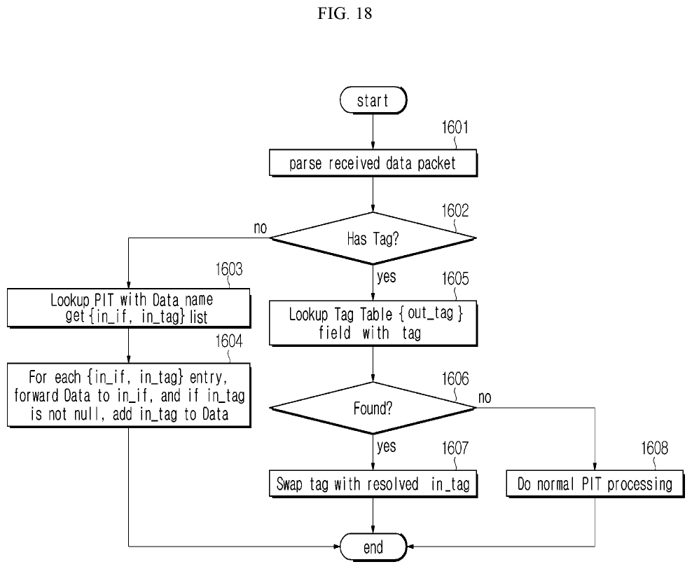

In one embodiment, the interest packet forwarding method for a data packet in FIG. 14 may be based on the packet forwarding process of FIG. 13, FIG. 15 and FIG. 16, and the data packet forwarding method of FIG. 14 may be based on FIG. 18.

In one embodiment, a node performing the interest packet forwarding method of FIG. 14 may exist in a same network as a node in which a data requester is located, in a same network as a node in which a data owner is located or in any other network in which transit traffic is processed. In addition, the node may be a PE node or a non-PE node in FIGS. 6 to 8 and FIG. 19 but is not limited thereto.

In one embodiment, the node may receive 1801 a data packet of a content centric network first. The received data packet may be one of the data packets in FIG. 12. The data packet may be received through an interface of the node.

Next, the node may examine 1802 whether or not a tag is included in the received packet (data packet). When it is determined that a tag is included, since the tag corresponds to an output tag of a tag table, a matching entry may be searched for the output tag of the tag table. When the data packet does not include a tag, a PIT lookup may be performed 1603 based on a data name included in the data packet. This will be described in further detail in FIG. 18.

In one embodiment, the node may forward the received packet. Herein, when a tag is included in the received data packet, the data packet may be forwarded 1803 to another node based on the tag. When the forwarding is based on a tag table, since the data packet includes a tag value corresponding to the (out_tag) field of the tag table, the tag may be changed to the tag (in_tag) of tag table again and thus the packet forwarding may be performed. In addition, as the data packet may be forwarded through an incoming interface of an interest packet, symmetrical forwarding with interest packet forwarding may be performed. This may be the same as described above with reference to another drawing.

FIG. 15 is a view for describing a method of forwarding an interest packet in a PE node in a content centric network and FIG. 16 is a view for describing a method of forwarding an interest packet in a non-PE node in a content centric network.

More specifically, the packet forwarding method may include a case in which a node performing packet forwarding does not exist in a destination network, when the interest packet is forwarded from an external network to a network in which the node exists. In other words, the node may be a node performing transit traffic. Herein, the node may be a PE node or a non-PE node. When the node is a PE node, the node may select to perform packet forwarding to a tag table by a packet forward module (and/or a processor, PIT/tag table selection logic) and include a tag uniquely assigned to each incoming interface in an interest packet. Herein, the external network may be a customer network or another provider network. A tag may be used to enable a data packet to return via an interface in which an interest packet is input, that is, to enable the data packet to be forwarded in the reverse direction along the same path in which the interest packet was forwarded to a data owner.

Herein, FIG. 15 is a view for describing an interest packet forwarding process in a PE node, and FIG. 16 is a view for describing an interest packet forwarding process in a non-PE node.

In one embodiment, after the PE/non-PE node receives an interest packet, the packet forwarding process may include appropriate parsing 1301, 1401 and operation of necessary processing 1302, 1402 based on a content store (CS).

Next, it may be examined 1303, 1403 whether or not a network name of the interest packet is the same as a router region, that is, a region of node. FIG. 13 and FIG. 14 will describe a case, as an embodiment, in which the network name of the interest packet is different from the router region. A case in which the network name is identical to the router region 1304 will be described with reference to FIG. 15.

In one embodiment, when packet forwarding is performed by a PE node, it may be examined whether or not the received interest packet is received from an external network 1305. In other words, it may be examined whether the interest packet is included in transit traffic.

Herein, when the interest packet is received from the external network, it may be examined whether or not a tag is included in the interest packet 1306. When the tag is included, a tag table is searched for an entry including the tag, that is, a matching entry. Herein, it is possible to look up 1308 the tag table by the pair {tag, in_if} of the tag (tag) of current interest packet and an incoming interface in which the interest packet is received (in_if).

In one embodiment, when the received interest packet is not received from the external network, it is examined whether or not a tag is included in the interest packet 1309. When the tag is included, the same processing as when the packet is received from the external network may be performed. When the tag is not included, PIT processing may be normally performed 1311, and then FIB lookup may be performed. Herein, the FIB lookup may be performed based on a data name prefix FIB.

In the case of a non-PE node, the process may be performed irrespective of whether or not an interest packet is received from an external network. In other words, after necessary CS processing is performed 1402, it may be examined whether a tag is included in the interest packet 1405. When a tag is included, it is possible to look up 1407 the tag table by the pair {tag, in_if} of the tag (tag) of the current interest packet and an incoming interface in which the interest packet is received (in_if).

In one embodiment, when the matching entry exists in the tag table 1310, 1408, the tag of the interest packet may be swapped for an output tag (out_tag) of the matching entry 1314, 1410, and packet forwarding 1315, 1411 may be performed through FIB lookup. Herein, the FIB lookup may be performed based on a network name prefix FIB. In another embodiment, when there is no matching entry in the tag table 1310, 1408, an output (out_tag) value that is not used in the node may be newly assigned to add the {in_tag, in_if, out_tag} entry to the tag table, and the tag (in_tag) of the interest packet may be swapped for an output tag (out_tag) 1313, 1409. Next, as mentioned above, packet forwarding may be performed through FIB lookup 1315, 1411. Herein, the FIB lookup may be performed based on a data name prefix FIB. Meanwhile, even when the interest packet does not include a tag, in the case of a PE node, it is possible to include a tag in the interest packet by assigning a new tag to the packet based on an incoming interface (in_if) 1307. In this case, the tag table may express that no tag is included in the interest packet and a new tag is included. For example, {null, in_if, tag} entry may be added to the tag table. Herein, the tag, which is one of the added tag table entry fields, may be newly assigned.

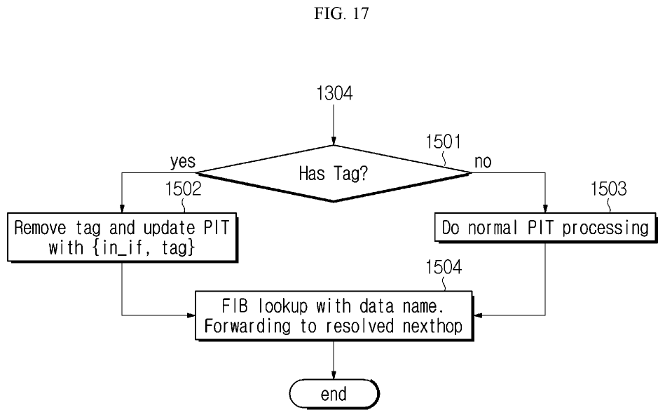

Through the above process, an interest packet including a tag may enter into a destination network, in which a data owner(producer) exists, through forwarding. A process after the interest packet enters into the destination network will be described in further detail with reference to FIG. 17.

Meanwhile, the above-mentioned interest packet, PIT and tag table may be the same as described above with reference to FIGS. 9 to 12.

FIG. 17 is a view for describing a method of forwarding an interest packet when a network name is the same as a router region in a content centric network according to an embodiment of the present disclosure. More specifically, FIG. 17 is a view for describing a method in which a PE/non-PE node of a destination network forwards an interest packet to a data owner.

In one embodiment, since an interest packet may have gone through the processes of FIG. 13 and FIGS. 15 to 16 before being forwarded to a destination network, the interest packet may be expressed as a local packet.

In one embodiment, when a PE/non-PE node confirms 1304 in an edge router that the destination of the interest packet is the network, the node may examine 1501 whether the interest packet includes a tag.

When a tag is included in the interest packet 1502, a tag may be stored in PIT by removing the tag of the interest packet. In this case, a pair of an incoming interface and the tag of the packet ({in_if, tag} or {tag, in_if}) may be stored in the PIT, and a current tag of the interest packet may be stored in the in_tag field.

On the other hand, when no tag is included in the interest packet (1503), normal PIT processing may be performed.

A data name prefix FIB lookup may be performed 1504, irrespective of whether the interest packet uses a tag. Thus, forwarding 1504 to a data owner in the network may be possible.

Meanwhile, the above-mentioned interest packet, PIT and tag table may be the same as described above with reference to FIGS. 9 to 12.

FIG. 18 is a view for describing a method of forwarding a data packet in a content centric network according to an embodiment of the present disclosure. More specifically, FIG. 18 is a view for describing a method of performing symmetrical forwarding in which a PE/non-PE node forwards a data packet as a response to an interest packet and a forwarding path of the data packet is identical with a forwarding path of the interest packet.

In one embodiment, the data packet, PIT and tag table, which are mentioned in FIG. 18, may be the same as described in FIGS. 9 to 12.

In one embodiment, the data packet may be received from a different node, and appropriate data packet parsing may be performed 1601. The data packet may have been forwarded from a node located either in a network to which a current node belongs or in an external network.

After performing necessary parsing, the node may examine whether or not the received data packet includes a tag 1602.

When the data packet includes a tag, data packet forwarding may be performed based on a tag table. In one embodiment, a tag table lookup may be performed based on the tag included in the data packet. In this case, based on the tag included in the data packet, the lookup is performed for the {out_tag} field of the tag table 1605, 1606. When there is a matching entry in the tag table, that is, when the lookup is successful, the tag included in the data packet may be swapped 1607 for a tag of the matching entry. In other words, since the tag included in the data packet may correspond to out_tag of the tag table, the tag may be swapped for a tag value in {in_tag} field of the matching entry. Meanwhile, when there is no matching entry in the tag table, that is, when the lookup failed, the data packet may be forwarded through normal PIT processing 1608.

Meanwhile, when the data packet does not include a tag, a PIT lookup may be performed 1603 based on a data name included in the data packet. That is, a lookup may be performed based on a data name to see whether or not there is a matching entry in a PIT. A pair of an incoming interface of interest packet and a tag ({in_if, in_tag} or {in_tag, in_if}) may be obtained in a matching entry. For the obtained pair of the interface and the tag, the data packet may include the obtained tag value (in_tag) and be forwarded through the interface (in_if).

Herein, when the tag value (in_tag) obtained from the PIT is null, the data packet may not include the tag and be forwarded through the interface (in_if) 1604. That is, “Data” in 1604 may mean the data packet.

Meanwhile, the above-mentioned interest packet, PIT and tag table may be the same as described above with reference to FIGS. 9 to 12.

FIG. 19 is a view for describing a node constituting a content centric network according to an embodiment of the present disclosure. More specifically, a node capable of implementing the above-mentioned packet forwarding method may be a node constituting a content centric network and be a packet processing apparatus or a computing system implementing a packet processing method in the content centric network.

In one embodiment, the node constituting a content centric network may include a PIT and a tag table 1901, one or more interfaces 1902, and a packet forward module 1903. As mentioned above, the PIT and tag table 1901 may be used to forward an interest packet to a data owner. As mentioned above, the one or more interfaces 1902 may be configured to receive and transmit an interest packet and a data packet for a plurality of remote nodes. As mentioned above, the packet forward module 1903 may perform packet forwarding by using the tag table and/or PIT.

In one embodiment, in the node that constitutes a content network and performs packet forwarding, a packet received through the interface may be the interest packet, and a network name of the received packet may be different from a router region. In this case, when a tag is included in the received packet, the packet forward module may forward the received packet by searching the tag table for an entry that matches a tag of the received packet and an interface of the received packet.

In addition, when the lookup is successful in the tag table, the packet forward module may swap the tag of the received packet for an output tag of the entry. When the lookup fails in the tag table, an output tag may be assigned to the received packet, and the packet forward module may swap the tag of the received packet for the output tag. When no tag is included in the received packet, the packet forward module may provide a tag to the received packet based on an interface in where the packet is received.

In addition, when the received packet is received from an internal network, forwarding of the received packet may be performed through a network name FIB lookup in the packet forward module. On the other hand, when the received packet is received from an internal network, forwarding of the received packet may be performed through a data name FIB lookup in the packet forward module.

In one embodiment, the packet received through the interface may be an interest packet, and the network name of the received packet may be the same as a router region. Also, in the packet forward module, forwarding of the received packet may be performed through a data name prefix FIB lookup. When a tag is included in the received packet, the PIT (Pending Interest Table) may be updated on the tag and the interface in which the packet is received.

In one embodiment, the tag table may include at least any one of a tag of the received packet, an output tag for forwarding the received packet, information on the last reception time of the received packet, and a flag for the aging management of the received packet. In addition, when the received packet is a data packet including an output tag, the packet forward module may forward the received packet by searching the tag table for an interface of interest packet matching the output tag. In this case, in the packet forward module, the output tag may be swapped for a tag of the interest packet associated with the matching interface.

In one embodiment, when the received packet is a data packet not including an output tag, the packet forward module may forward the received packet through a tag and an interface of an interest packet, which are obtained based on a data name prefix in a pending interest table (PIT).

Meanwhile, although not illustrated in FIG. 19, the node and/or apparatus of FIG. 19 may include a processor, a storage, a bus, a PIT, a FIB, a CS and a memory including a random access memory (RAM) and a read only memory (ROM).

The various forms of the present disclosure are not an exhaustive list of all possible combinations, and are intended to describe representative aspects of the present disclosure, and the matters described in the various forms may be applied independently or in combination of two or more.

In addition, various forms of the present disclosure may be implemented by hardware, firmware, software, or a combination thereof. In the case of hardware implementation, one or more application specific integrated circuits (ASICs), digital signal processors (DSPs), digital signal processing devices (DSPDs), programmable logic devices (PLDs), field programmable gate arrays A general processor, a controller, a microcontroller, a microprocessor, and the like may be used for implementation. For example, the present disclosure may be implemented by a type of program stored in a non-transitory computer readable medium that may be used on a terminal or an edge or be implemented by a type of program stored in a non-transitory computer-readable medium that may be used on an edge or a cloud. In addition, the present disclosure may also be implemented in various combinations of hardware and software.

An autonomous control program for things through imitation learning according to an embodiment of the present disclosure may be a program stored in a non-transitory computer-readable medium. The autonomous control program may implement: obtaining an output value of a thing operating according to an action command based on a policy in a computer; determining compensation for the policy; and updating the policy so that the compensation may be optimized.

The scope of the present disclosure includes software or machine-executable instructions (for example, an operating system, applications, firmware, programs, etc.) that enable operations according to the methods of various embodiments to be performed on a device or computer, and a non-transitory computer-readable medium in which such software or instructions are stored and are executable on a device or computer.

It will be apparent to those skilled in the art that various substitutions, modifications and changes are possible are possible without departing from the technical features of the present disclosure. It is therefore to be understood that the scope of the present disclosure is not limited to the above-described embodiments and the accompanying drawings.

What is claimed is:

1. A node constituting a content centric network for packet forwarding, the node comprising:
a plurality of interfaces configured to receive and transmit an interest packet and a data packet for a plurality of remote nodes;
a pending interest table (PIT) for storing information on a local interest packet, among non-responded interest packets, of which its source network or destination network is the network in which the corresponding node is located;
a tag table for storing information on a transit interest packet group associated with a source network, among non-responded interest packets, of which its source network and destination network are not the network in which the corresponding node is located;
a forwarding information base (FIB) for forwarding an interest packet to a destination node; and
a processor for selecting the PIT or the tag table, when packet forwarding, according to whether the packet is a local packet or a transit packet, and for performing packet forwarding based on the selected table.

2. The node of claim 1,
wherein, when a destination network name of an interest packet received from an interface connected with an external network is not the same as the network name in which a node is located, or
when a tag is comprised in an interest packet received by an interface connected with the internal network,
the processor classifies the received interest packet as a transit interest packet.

3. The node of claim 1,
wherein, when an interest packet received from an interface connected with an internal network does not comprise a tag, or
when an interest packet, of which its destination network name is the same as the network name in which a node is located, is received in an interface connected with an external network,
the processor classifies the received interest packet as a local interest packet.

4. The node of claim 2,
wherein, when a tag is comprised in the received transit interest packet,
the processor looks up, in the tag table, an entry matching information associated with a tag of the received packet and the receiving interface of the packet.

5. The node of claim 4,
wherein, when the tag table lookup is successful, the processor swaps the tag of the received packet for an output tag of the entry.

6. The node of claim 4,
wherein, when the lookup fails in the tag table, the processor assigns a new output tag and swaps the tag of the received packet for the new output tag

7. The node of claim 2,
wherein, when no tag is comprised in the received transit interest packet, the processor assigns a tag to the received packet based on information associated with the interface in which the packet is received.

8. The node of claim 7,
wherein information associated with the tag assigned to the packet and the interface is added to the tag table.

9. The node of claim 3,
wherein, when the received local interest packet comprises a tag, the tag is removed from a header and information on the tag and the receiving interface is stored in a PIT entry of the interest.

10. The node of claim 1,
wherein each entry of the PIT comprises information on the tag of a received interest packet and its receiving interface.

11. The node of claim 3,
wherein the FIB comprises a network name FIB and a data name prefix FIB.

12. The node of claim 11,
wherein, when a received interest packet is a transit interest packet, the processor forwards the packet through the network name FIB lookup.

13. The node of claim 11,
wherein, when a received interest packet is a local interest packet, the processor performs packet forwarding through the data name prefix FIB lookup.

14. The node of claim 1,
wherein the tag table comprises a tag of the received packet and an output tag for forwarding the received packet and further at least one of last access time information of the tag table entry and a flag for aging management of the tag table entry.

15. The node of claim 1,
wherein, when a data packet is received through the interface and the data packet comprises a tag, the processor looks up an entry matching the tag in the output tag column of the tag table.

16. The node of claim 15,
wherein the processor swaps the tag for the interest packet tag of the matching entry, and
wherein the processor forwards the received packet to an interface of the matching entry.

17. The node of claim 1,
wherein, when the received packet is a data packet not comprising an output tag, the processor looks up PIT for the matching PIT entry with a data name of the data packet, and
wherein, when the lookup is successful, the processor adds a tag of the matching interest packet to the data packet and forwards the packet based on information on an interface in which the interest packet is received.

18. A packet forwarding method performed by a node constituting a content centric network, the method comprising:
receiving an interest packet from a content centric network;
examining whether a tag is comprised in the received interest packet; and
forwarding the interest packet,
wherein, when the interest packet is received by an interface connected with an external network and its destination network name of the interest packet is not the same as a network name in which the node is located, or
when the interest packet is received by an interface connected with an internal network and a tag is comprised in the interest packet,
the received interest packet is classified as a transit interest packet.

19. The packet forwarding method of claim 18,
wherein, when the interest packet is received in an interface connected with the internal network and does not comprise a tag, or
when the interest packet is received in an interface connected with an external network and its destination network name of the interest packet is the same as a network name in which the node is located, the received interest packet is classified as a local interest packet.

20. A packet forwarding method performed by a node constituting a content centric network, the method comprising:
receiving a data packet of a content centric network;
examining whether a tag is comprised in the received data packet; and
forwarding the data packet,
wherein, when a tag is comprised in the received data packet, an entry comprising an output tag matching the tag is looked up in a tag table and forwarding is performed based on interface information comprised in the entry.
